(19) United States
(12) Patent Application Publication
(10) Pub. No.: US 2001/0049308 A1
(43) Pub. Date: Dec. 6, 2001

(54) TRIPOD BEARING ASSEMBLY

(76) Inventors: ROBERT W. SAMS, CLINTON TOWNSHIP, MI (US); RICHARD SEIDEL, MACOMB TOWNSHIP, MI (US); MICHAEL WALTER HOPSON, CLINTON TOWNSHIP, MI (US)

Correspondence Address: JOHN G. CHUPA. ESQ., 31313 NORTH WESTERN HIGHWAY, SUITE 205, FARMINGTON, HILLS, MI, 48334, US

(21) Appl. No.: 08/996,249

(22) Filed: Dec. 22, 1997

(51) Int. Cl. F16D 3/16; F16D 3/20; F16D 3/26; F16D 3/50

(52) U.S. Cl. 464/122

(57) ABSTRACT

A tripod bearing assembly is provided including a spider assembly with a trunion. A bearing assembly is press fit onto the trunion. The bearing assembly has an inner race, an outer race, and a plurality of needle rollers to permit relative rotation between the inner and outer races. The bearing assembly is axially retained to the spider.

### FIELD OF THE INVENTION

The present invention relates to a tripod bearing assembly particularly for a motor vehicle.

### BACKGROUND OF THE INVENTION

Tripod bearing assemblies of the prior art include a spider with three trunions drivably engaged with an outer member to transmit torque from a first shaft to a second shaft. The tripod bearing assembly permits angular and axial displacement between the two shafts during dynamic rotation of the assembly. Typically, a needle bearing is provided between each trunion and the outer member.

The needle bearing of the prior art is generally assembled to the trunion in one of two manners and particularly designed therefor. A first bearing type and assembly method is illustrated in FIG. 1. The trunion supports a plurality of needles which support a roller which engages a branch of an outer member of a constant velocity joint. In the prior art assembly shown in FIG. 1, the needles bear directly on a bearing surface machined onto the trunion. An outer bearing is provided between the needles and the outer member (the outer member is not shown). The needles are therefore assembled between the trunion and the outer bearing. Such an assembly requires a large amount of labor or specialized machinery to enable the assembly of the individual needles in this manner. It would therefore be desirable to provide an assembly in which the needles were assembled in a subassembly prior to installation onto the trunion.

A second type of bearing is illustrated in FIGS. 2 and 3. This assembly includes a preassembled needle bearing interposed between a trunion and outer member. The needles are assembled into a bearing assembly prior to installation of the bearing assembly onto a trunion.

The prior art assembly shown in FIGS. 2 and 3 includes a means for displacing the bearing assembly relative to the trunion. As illustrated in FIG. 2, the displacement comprises an angular movement of the trunion relative to the inner race of the bearing assembly.

FIG. 3 illustrates an alternate means for displacing the bearing assembly relative to the trunion comprising an axial movement of the trunion relative to the inner race of the bearing assembly. These prior art configurations require a bearing provided between the trunion and the needle bearing and also require additional machining of the trunion to permit the axial sliding movement. It would be desirable to provide a trunion assembly which includes needle bearings which are preassembled into a bearing assembly which is subsequently assembled onto the trunion, but which does not require relative axial or rotational movement to the trunion, so machining of the trunion is minimized.

### SUMMARY OF THE INVENTION

In accordance with the objects of this invention, an improved tripod assembly is provided. The tripod bearing assembly includes a spider assembly with a trunion. A bearing assembly is press fit onto the trunion. The bearing assembly has an inner race, an outer race, and a plurality of needle rollers to permit relative rotation between the inner and outer races. The bearing assembly is axially retained to the spider. The trunion therefore does not require machining and the bearing is preassembled prior to installation onto the trunion.

### BRIEF DESCRIPTION OF THE DRAWINGS

FIG. 1 is an exploded view of a prior art trunion of a tripod bearing assembly.

FIG. 2 is a partial side sectional view of an alternative prior art tripod bearing assembly.

FIG. 3 is a partial end sectional view of the prior art tripod shown in FIG. 2.

FIG. 4 is a partial sectional view of a needle roller assembly being installed on a trunion according to the present invention.

FIG. 5 is a partial sectional view of a needle roller assembly being installed on a trunion according to an alternative embodiment of the present invention.

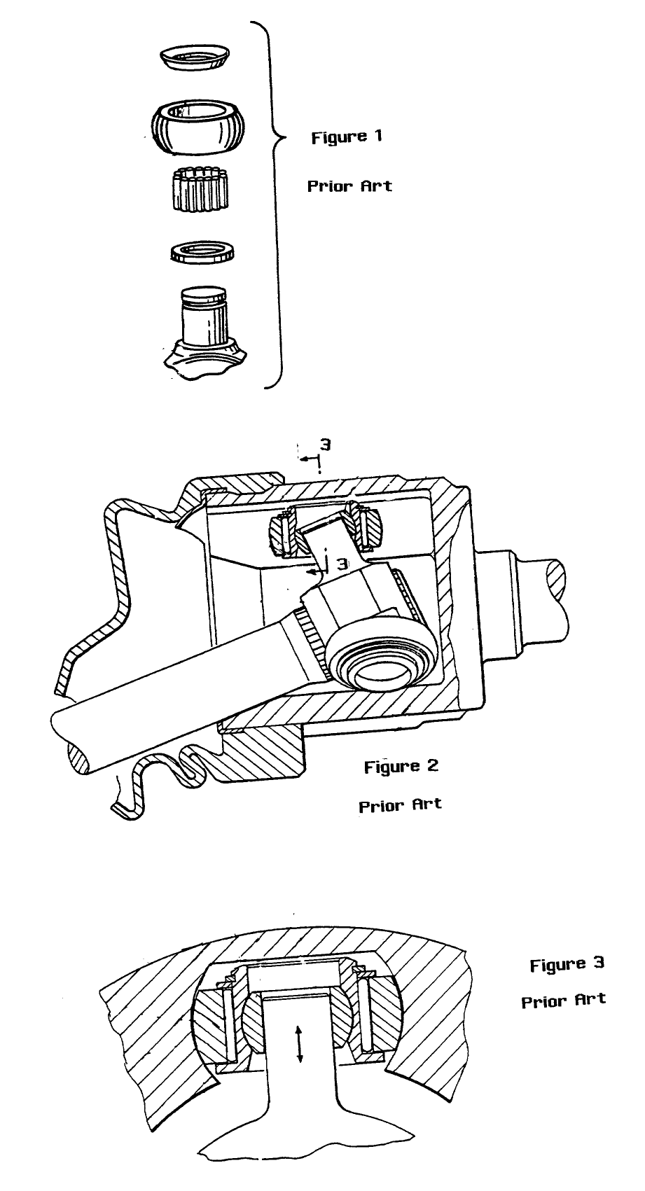

### DETAILED DESCRIPTION OF PREFERRED EMBODIMENTS

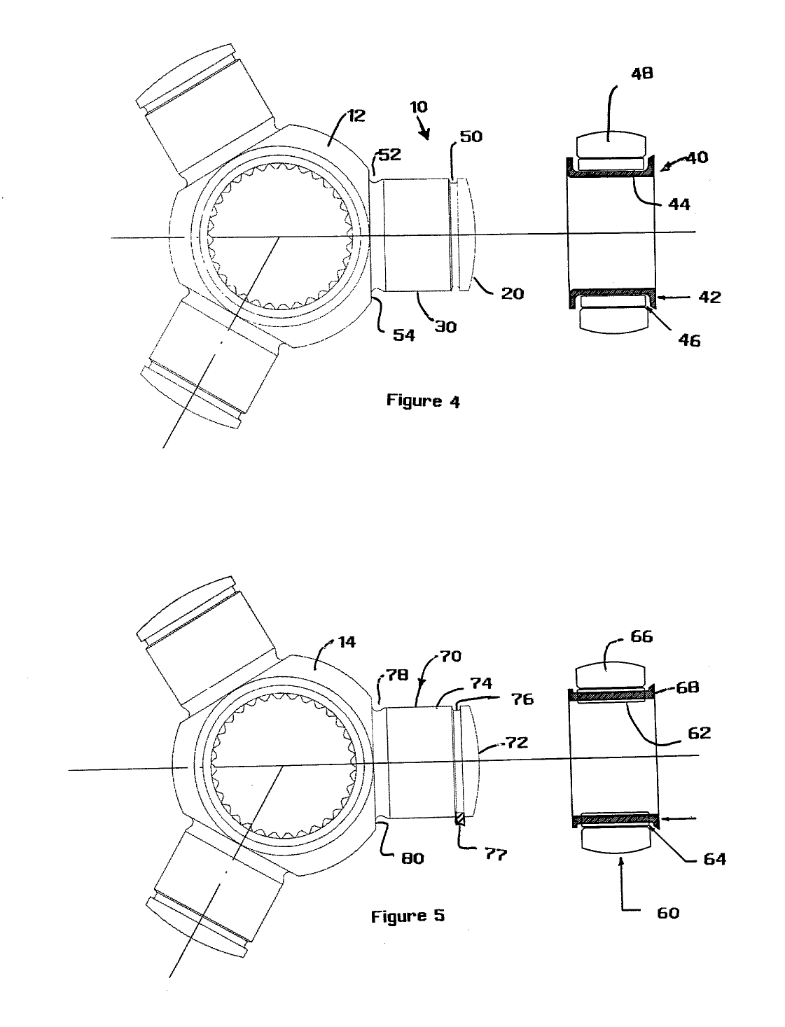

FIG. 4 illustrates a tripod bearing assembly 10. The assembly 10 includes a spider 12 having three trunions 20 equally spaced. A bearing 40 is pressed fit onto the trunion 20. The bearing 40 includes an inner race 42 supporting a plurality of needles 46, and an outer race 48 supported by the needles 46. In a preferred embodiment, the inner race comprises a formed cup, preferably formed by drawing the inner race to the necessary shape. The outer race 48 is rotatable relative to the inner race 42 on the needles 46. The outer race 48 drivably engages an outer member (not shown) in a manner known to one skilled in the art.

The trunion 20 includes an outer diameter 30 which is sized to be press fit to the inner surface 44 of the inner bearing 40. The press fit of the bearing 40 to the trunion 20 and the inner race 42 eliminate the need for machining (such as turning or grinding) of the outer diameter 30 of the trunion 20, since it is not a bearing surface. Thus, the trunion may be assembled “as formed” without finish machining in this embodiment. The spider 12 could, for example, be forged, then have the bearing assemblies 40 press fit onto the trunions 20, then finally assembled into a constant velocity joint assembly for use in an automobile.

An undercut 52 is preferably formed on the trunion to further eliminate the need for any finish machining of the spider at this surface. The bearing 40 is axially restrained in a first direction by a shoulder 54 provided on the spider adjacent undercut 52. A snap ring groove 50 is provided at the distal end of the trunion 20 to engage a snap ring (not shown) to axially retain the bearing 40 to the spider 12 in the opposite direction. Thus, during operation of the joint 10, the bearing 40 is axially fixed to the trunion 20 between the snap ring groove 50 and the shoulder 54 without the need for finish machining. The press fit also aids in axially retaining the bearing 40 to the trunion 20.

The outer race 48 rotates circumferentially about the trunion 20. The outer member (not shown) is able to rotate or move axially relative to the outer race 48 in a manner known to one skilled in the art, similar to the manner described in U.S. Pat. No. 4,693,698, which is incorporated herein by reference. The tripod thus accommodates any angular deflection of the joint or relative axial movement.

The bearing surface 30 of the trunion 20 comprises a cylinder. The engagement of this cylindrical trunion with the inner surface 44 of the bearing 40 prevents angular displacement therebetween.

In an alternative embodiment, as shown in FIG. 5, a bearing assembly 60 is fit onto a spider 14. The spider includes three trunions 72 as described above with reference to FIG. 4. Each trunion 72 includes a finished bearing surface 74. The needles 64 of the bearing 60 rotate at 62 on the bearing surface 74 as an inner race in a manner similar to that described in the '698 patent. The bearing 60 includes a plurality of needles 64, an outer race 66, and a cage 68 to retain the needles 64 after assembly to the outer race 66, prior to installation onto the trunion 72. Thus the bearing assembly 60 is shipped as a modular unit and pressed fit onto the trunion 14 in a simple manner, without the need to handle loose needles at the tripod assembly source. The cage is preferably made from a glass-filled polymer as is known to one skilled in the art. The cage includes a plurality of pockets for retaining the needles to the outer race as is known to one skilled in the art. In an alternative embodiment, the cage is formed from steel.

In a manner similar to that described above with reference to FIG. 4, the bearing 60 is retained after assembly in a first axial direction by a shoulder 80 provided on the spider 14 adjacent trunion 72. An undercut 78 is provided on the trunion 72 to simplify finish machining. A groove 76 is provided at the opposite end of the trunion 72. A snap ring 77 is installed in the groove 76 after the bearing 60 is assembled to retain the bearing 60 in the second axial direction. In this embodiment, the trunion preferably includes a ground surface 74, since it is a bearing surface. The cage 68 serves as an assembly aid to prevent the need for assembling the needles at final assembly of the joint, as the bearing 60 is shipped as an assembly.

The above spider assembly has been describe with reference to a constant velocity joint. However, one skilled in the art recognizes that these concepts maybe used in a universal joint.

It is to be understood that the embodiments of the invention described above are merely illustrative of application of principals of the present invention. Numerous modifications maybe made to the methods and apparatus described above without departing from the true spirit and scope of the invention.

What is claimed is:

1. A tripod bearing assembly comprising:
a spider assembly having a trunion radially projecting therefrom;
a bearing assembly press fit onto the trunion, the bearing assembly comprising an inner race, an outer race, and a plurality of needle rollers interposed therebetween to permit relative rotation between the inner and outer race; and
means for axially retaining the bearing assembly to the spider.

2. A spider assembly according to claim 1, further comprising said trunion having a non-machined outer surface for press-fit engagement with the inner race of the bearing assembly.

3. A spider assembly according to claim 2, further comprising a means for angularly retaining the bearing to the trunion.

4. A bearing assembly according to claim 3, wherein the inner race comprises a formed cup.

5. A bearing assembly according to claim 4, wherein the cup is formed by drawing.

6. A method of assembling a tripod bearing assembly including a spider, comprising:
forming a plurality of trunions on the spider;
press fitting a bearing assembly onto the trunion, the bearing assembly comprising an inner race, an outer race, and a plurality of rollers interposed therebetween to permit relative rotation between the inner and outer race; and
axially retaining the bearing assembly to the spider.

7. A method according to claim 6, wherein the trunion is forged and the bearing is press-fit onto the trunion without machining the trunion.

8. A method according to claim 7, further comprising the step of angualrly retaining the bearing to the trunion.

9. A method according to claim 8, further comprising the step of drawing the inner race.

10. A tripod bearing assembly including a spider, comprising:
a non-machined trunion radially provided on the spider, the trunion comprising an undercut adjacent the spider, a cylindrical surface, and a snap ring groove axially spaced from the undercut;
a bearing assembly press-fit onto the trunion between the spider and snap ring groove, the bearing assembly comprising an inner race, an outer race, and a plurality of needle rollers interposed therebetween to permit relative rotation between the inner and outer race; and
means for axially and angularly retaining the bearing assembly to the spider.

11. A bearing assembly according to claim 10, wherein the inner race comprises a formed cup.

12. A bearing assembly according to claim 11, wherein the cup is formed by drawing.
